(19) United States
(12) Patent Application Publication
(10) Pub. No.: US 2006/0100982 A1
(43) Pub. Date: May 11, 2006

(54) Storage configuration loader with automatic error recovery

(75) Inventor: Jeremy Andrew Cohn, Tucson, AZ (US)

Correspondence Address: Allen K. Bates;International Business Machines Corporation, 9000 South Rita Road, Tucson, AZ, 85744, US

(73) Assignee: International Business Machines Corporation, Armonk, NY (US)

(21) Appl. No.: 10/983,852

(22) Filed: Nov. 8, 2004

(51) Int. Cl. G06F 17/30

(52) U.S. Cl. 707/1

(57) ABSTRACT

Disclosed are a system, a method, and article of manufacture to configure information storage and retrieval systems. A configuration loader receives configuration commands from a configuration loader user interface. The configuration loader comprises a configuration loader module and at least one database. Upon receipt of configuration commands, the configuration loader module generates a list of tasks necessary to configure the target information storage and retrieval system to be equivalent to the information storage and retrieval system configuration source. The configuration loader module stores the list of tasks in the database and the configuration loader module configures the target information storage and retrieval system by executing the list of tasks. If the configuration process is interrupted before the target configuration is complete, the system automatically recovers and continues to execute the list of tasks necessary to configure the target.

### CROSS-REFERENCES TO RELATED APPLICATIONS

The present application is related to application Ser. No. ______, entitled “Storage Configuration Loader: verification algorithms”, Docket # TUC9-2004-00069, application Ser. No. ______, entitled “Storage Configuration Loader”, Docket # TUC9-2004-00079 and application Ser. No. ______, entitled “Storage Configuration Loader Using Cache For Fast Retrieval Of Storage Configurations”, Docket # TUC9-2004-00080, all filed on an even date herewith, the disclosures of which are hereby incorporated by reference in their entirety.

### TECHNICAL FIELD

This invention relates to an apparatus and method to configure information storage and retrieval systems.

### BACKGROUND OF THE INVENTION

Data storage and retrieval systems are used to store information provided by one or more host computer systems. Such data storage and retrieval systems receive requests to write information to one or more secondary storage devices, and requests to retrieve information from those one or more secondary storage devices. Upon receipt of a write request, the system stores information received from a host computer in a data cache. In certain implementations, a copy of that information is also stored in a nonvolatile storage device. Upon receipt of a read request, the system recalls information from the one or more secondary storage devices and moves that information to the data cache. Thus, the system is continuously moving information to and from storage devices, and to and from the data cache.

In certain data processing applications, data is copied to multiple individual information storage and retrievals systems. Such copy service applications include, for example, peer-to-peer remote copy operations. In such applications, data is copied from an information storage and retrieval system source to a target information storage and retrieval system. Some of these copy service applications require both the source and target information storage and retrieval systems to have identical physical and logical configurations. In other data processing applications, it is advantageous to configure the source and target information storage and retrieval systems to be physically and logically similar to facilitate efficient transfer of data. Transferring configurations from a source to a target to accomplish the configuration of the target is often used to produce a target that is compatible with the source. Often a large number of logical objects must be configured at the target, resulting in a time consuming configuration process. In certain circumstances, the transfer process may be interrupted before the transfer is complete. Depending upon the system used for the configuration transfer, this may result in restarting the transfer process from the beginning each time an interruption occurs. This adds further delays to completing the configuration transfer and increased downtime for the source and/or target information storage and retrieval systems.

What is needed is system to configure information storage and retrieval system that automatically recovers from interruptions.

### SUMMARY OF THE INVENTION

The present invention provides a system, a method and an article of manufacture to configure information storage and retrieval systems and to automatically recover from interruptions in the configuration process.

In method form, exemplary embodiments include a method to configure information storage and retrieval systems. The method comprises the steps of providing a configuration loader user interface for accepting configuration commands and providing a configuration loader capable of communicating with the configuration loader user interface, with an information storage and retrieval system configuration source and with a target information storage and retrieval system. The configuration loader comprises a configuration loader module and at least one database. Operative to the configuration loader receiving a command from the configuration loader user interface to configure the target information storage and retrieval system to be equivalent to the configuration source, the configuration loader module generates a list of tasks necessary to configure the target information storage and retrieval system to be equivalent to the information storage and retrieval system configuration source. The configuration loader module stores the list of tasks in the database and the configuration loader module configures the target information storage and retrieval system by executing the list of tasks.

In method form, exemplary embodiments further include that operative to the configuration loader detecting an incomplete execution of a failed task, the configuration loader performs a verification of communications necessary for the configuration loader operation. Operative to the configuration loader successfully verifying the communications necessary for the configuration loader operation, the configuration loader module executes the list of tasks beginning with the failed task.

In system embodiments the present invention provides a system to configure information storage and retrieval systems. The system comprises a configuration loader user interface for accepting configuration commands, an information storage and retrieval system configuration source, a target information storage and retrieval system and a configuration loader capable of communicating with the configuration loader user interface, with the information storage and retrieval system configuration source and with the target information storage and retrieval system. The configuration loader comprises a configuration loader module and a database. The configuration loader module comprises a configuration loader processor for execution of the configuration commands and a thread manager for managing one or more transfer threads to accomplish one or more configuration transfers.

In further system embodiments, the configuration loader is adapted so that operative to the configuration loader receiving a command from the configuration loader user interface to configure the at least one target information storage and retrieval system to be equivalent to the configuration source, the configuration loader module generates a list of tasks necessary to configure the target information storage and retrieval system to be equivalent to the information storage and retrieval system configuration source. The configuration loader module stores the list of tasks in the database and the configuration loader module configures the target information storage and retrieval system by executing the list of tasks.

These and other benefits of the present invention will be discussed in the following detailed description, which describes aspects of an exemplary system, apparatus, and procedure of the present invention. It will be appreciated by those skilled in the art that although the following detailed description will proceed with reference being made to preferred embodiments and methods of use, the present invention is not intended to be limited to these preferred embodiments and methods of use. Rather, the present invention is intended to be limited only as set forth in the accompanying claims. For a more detailed understanding of the present invention, reference may be made to the following detailed description taken in conjunction with the accompanying drawings.

### BRIEF DESCRIPTION OF THE DRAWINGS

Referring now to the drawings in which like reference numbers represent corresponding parts throughout.

FIG. 1 is an illustration of one embodiment of Applicant's data processing system.

FIG. 2 is an illustration of one embodiment of Applicant's information storage and retrieval system.

FIG. 3 is an illustration of one embodiment of Applicant's configuration loader system.

FIG. 4 is an illustration of one embodiment of Applicant's thread management system.

FIG. 5 illustrates a flowchart showing a process to implement an embodiment of the present invention to configure information storage and retrieval systems.

FIG. 6 illustrates a flowchart showing a process to implement an embodiment of the present invention to automatically recover from interruptions during a configuration transfer.

FIG. 7 illustrates an example of a task list of configuration actions for use with an embodiment of the present invention.

### DETAILED DESCRIPTION OF THE PREFERRED EMBODIMENTS

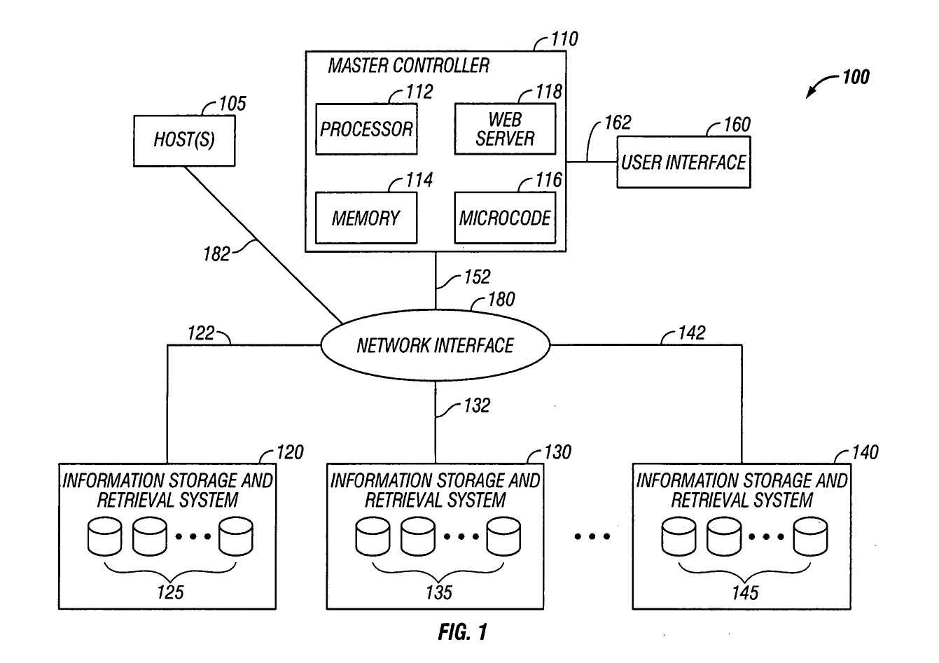

Referring now to FIG. 1, Applicant's data processing system 100 includes a master controller 110 in combination with a plurality of information storage and retrieval systems. For example, in the illustrated embodiment of FIG. 1, Applicant's data processing system 100 includes master controller 110 in combination with information storage and retrieval systems 120, 130, 140, and additional systems not shown.

In certain embodiments, Applicant's system further includes a network interface 180. Network interface 180 may be, for example, a Storage Attached Network (“SAN”), a local area network (LAN), a wide area network (WAN), a private network or combinations thereof. In these embodiments, master controller 110 is capable of communicating with network interface 180 via communication link 152.

Master controller 110 includes processor 112, memory 114, and microcode 116. In certain embodiments, memory 114 comprises non-volatile memory, such as for example, one or more EEPROMs (Electrically Erasable Programmable Read Only Memory), one or more flash PROMs (Programmable Read Only Memory), battery backup RAM, hard disk drive, combinations thereof, and the like.

User interface 160 communicates with master controller 110 via communication link 162. In certain embodiments, communication link 162 may be implemented as network interface 180. In certain embodiments master controller 110 may include user interface 160. In other embodiments, master controller 110 further includes web server 118 which is capable of bidirectional communication using an Internet access link to user interface 160. Host computer 105 is capable of communication with any of the components of data processing system 100 using network interface 180 via communication link 182. In other embodiments, host computer 105 may communicate with any of the components of data processing system 100 directly using for example, a host adapter.

In the illustrated embodiment of FIG. 1, master controller 110 is external to each of Applicant's information storage and retrieval systems comprising system 100. In other embodiments, master controller 110 is integral with one of the information storage and retrieval systems comprising Applicant's data processing system.

Master controller 110 is capable of bidirectional communication with information storage and retrieval systems 120, 130, and 140, using network interface 180, communication link 152 and communication links 122, 132, and 142, respectively. In the illustrated embodiment of FIG. 1, master controller 110 communicates with a plurality of information storage and retrieval systems using network interface 180, such as for example, a SAN. In other embodiments, master controller 110 may also communicate directly with any of the information storage and retrieval systems. In yet other embodiments, master controller 110 communicates directly with one or more information storage and retrieval systems, and with one or other information storage and retrieval systems using network interface 180.

Communication links 122, 132, 142, 152 162 and 182, are independently selected from the group comprising a wireless communication link, a serial interconnection, such as RS-232 or RS-422, an ethernet interconnection, a SCSI interconnection, an iSCSI interconnection, a Gigabit Ethernet interconnection, a Bluetooth interconnection, a Fibre Channel interconnection, an ESCON interconnection, a FICON interconnection, a Local Area Network (LAN), a private Wide Area Network (WAN), a public wide area network, Storage Area Network (SAN), Transmission Control Protocol/Internet Protocol (TCP/IP), the Internet, and combinations thereof.

Information storage and retrieval system 120 includes a plurality of information storage media 125. In certain embodiments, plurality of information storage media 125 comprises one or more hard disk drives, one or more tape storage media, one or more optical storage media, one or more electronic storage media, and combinations thereof.

Information storage and retrieval system 130 includes a plurality of information storage media 135. In certain embodiments, plurality of information storage media 135 comprises one or more hard disk drives, one or more tape storage media, one or more optical storage media, one or more electronic storage media, and combinations thereof.

Information storage and retrieval system 140 includes a plurality of information storage media 145. In certain embodiments, plurality of information storage media 145 comprises one or more hard disk drives, one or more tape storage media, one or more optical storage media, one or more electronic storage media, and combinations thereof.

As those skilled in the art will appreciate, information and retrieval storage systems 120, 130, and 140, may comprise elements in addition to the plurality of storage media shown. As those skilled in the art will further appreciate, such information storage and retrieval systems may further include, without limitation, one or more processors, one or more data buffers, one or more DASD devices, one or more data caches, one or more input/output adapters, one or more storage device adapters, one or more operator input panels, one or more web servers, one or more robotic accessors, one or more data storage devices which include the plurality of storage media 125, and the like.

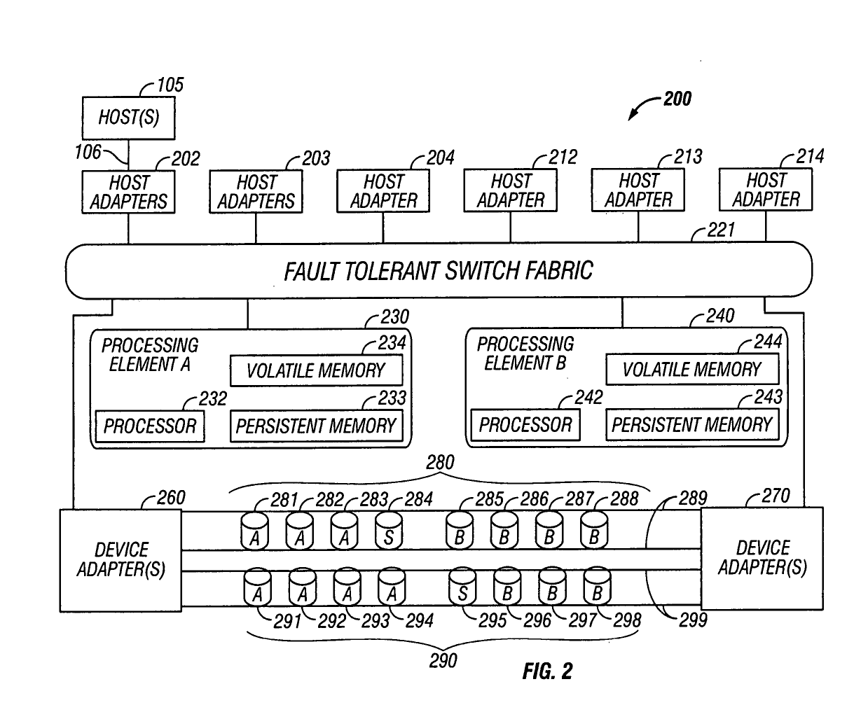

Referring now to FIG. 2, in certain embodiments, one or more of information storage and retrieval systems 120 (FIG. 1), 130 (FIG. 1) and 140 (FIG. 1) comprises information storage and retrieval system 200. Information storage and retrieval system 200 is capable of communication with host computer 105 via communication link 106. The illustrated embodiment of FIG. 2 shows a single host computer. In other embodiments, Applicant's information storage and retrieval system is capable of communicating with a plurality of host computers.

Host computer 105 comprises a computer system, such as a mainframe, personal computer, workstation, and combinations thereof, including an operating system such as Windows, AIX, Unix, MVS, LINUX, etc. (Windows is a registered trademark of Microsoft Corporation; AIX is a registered trademark and MVS is a trademark of IBM Corporation; and UNIX is a registered trademark in the United States and other countries licensed exclusively through The Open Group.) In certain embodiments, host computer 105 further includes a storage management program. The storage management program in the host computer 105 may include the functionality of storage management type programs known in the art that manage the transfer of data to a data storage and retrieval system, such as the IBM DFSMS implemented in the IBM MVS operating system.

In certain embodiments, Applicant's information storage and retrieval system 200 includes a plurality of host adapters 202, 203, 204, 212, 213 and 214, disposed in host bays (not shown). In other embodiments, Applicant's information storage and retrieval system includes more or less than the six host adapters shown. Regardless of the number of host adapters disposed in any embodiments of Applicant's system, each of those host adapters comprises a shared resource that has equal access to both processing elements 230 and 240. Each host adapter may comprise one or more Fibre Channel ports, one or more FICON ports, one or more ESCON ports, or one or more SCSI ports or other interface protocol known in the art. Each host adapter is connected to both processing elements 230 and 240 through fault tolerant switch fabric 221 such that each processing element 230, 240 can manage I/O from any host adapter.

Processor element 230 includes processor 232, volatile memory 234 and persistent memory 233. In certain embodiments, memory devices 233, 234 comprise random access memory or non-volatile memory. Cache may be implemented in any of the elements of processor element 230.

Processor element 240 includes processor 242, volatile memory 244 and persistent memory 243. In certain embodiments, memory devices 243, 244 comprise random access memory or non-volatile memory. Cache may be implemented in any of the elements of processor element 240.

I/O to storage devices portion 260 comprises a plurality of device adapters, such as device adapters for interfacing to storage devices. I/O portion 270 further comprises a plurality of device adapters, such as device adapters for interfacing to storage devices.

In certain embodiments of Applicant's system, one or more host adapters, processor element 230 and one or more device adapters are packaged together on a single card disposed in Applicant's information storage and retrieval system. Similarly, in certain embodiments, one or more host adapters, processor element 240 and one or more device adapters are disposed on another card disposed in Applicant's information storage and retrieval system. In these embodiments, Applicant's system 200 includes two cards interconnected with a plurality of data storage devices.

In the illustrated embodiment of FIG. 2, sixteen data storage devices are organized into two arrays, namely array “A” and array “B”. The illustrated embodiment of FIG. 2 shows two storage device arrays. In other embodiments, Applicant's information storage and retrieval system includes more than two storage device arrays. Each storage array appears to a host computer as one or more logical devices.

In certain embodiments, one or more of the data storage devices comprise a plurality of hard disk drive units. In the illustrated embodiment of FIG. 2, disk array “A” includes disk drives 281, 282, 283, 291, 292, 293, and 294. Disk array “B” includes disk drives 285, 286, 287, 288, 296, 297, and 298. In certain embodiments, arrays “A” and “B” utilize a RAID (Redundant Array of Independent Disks) protocol. In certain embodiments, arrays “A” and “B” comprise what is sometimes called a JBOD array, i.e. “Just a Bunch Of Disks” where the array is not configured according to RAID. As those skilled in the art will appreciate, a RAID rank comprises independent disk drives configured in an array of disk drives to obtain performance, capacity and/or reliability that exceeds that of a single large drive. In the illustrated embodiment of FIG. 2, disks labeled “S” indicates a spare disk that may be used to replace a failed data disk. The spare disks include disk drives 284 and 295. The data disks, in this figure, are 281, 282, 283, 291, 292, 293, 294, 285, 286, 287, 288, 296, 297, and 298

The illustrated embodiment of FIG. 2 shows two storage device arrays. In other embodiments, Applicant's system includes a single storage device array. In yet other embodiments, Applicant's system includes more than two storage device arrays.

The interface structure 289, 299 to storage devices 280, 290 shown in FIG. 2 comprises one embodiment of Applicant's system. In other embodiments, link 289 and/or 299 comprises a switched fabric or a combination of a switch and loop topologies. In other embodiments, link 289 and/or 299 comprises dual FC-AL loops of switches. Each loop contains one or more Fibre Channel switches.

In certain embodiments, one or more Applicant's information storage and retrieval systems 120, 130, 140 comprises an automated media library comprising a plurality of tape cartridges, one or more robotic accessors, and one or more tape drives. U.S. Pat. No. 5,970,030, assigned to the common assignee herein, describes such an automated media library and is hereby incorporated by reference. In certain embodiments, one or more of Applicant's information storage and retrieval systems 120, 130, 140 comprises a virtual tape system. U.S. Pat. No. 6,269,423, assigned to the common assignee herein, describes such a virtual tape system, and is hereby incorporated by reference.

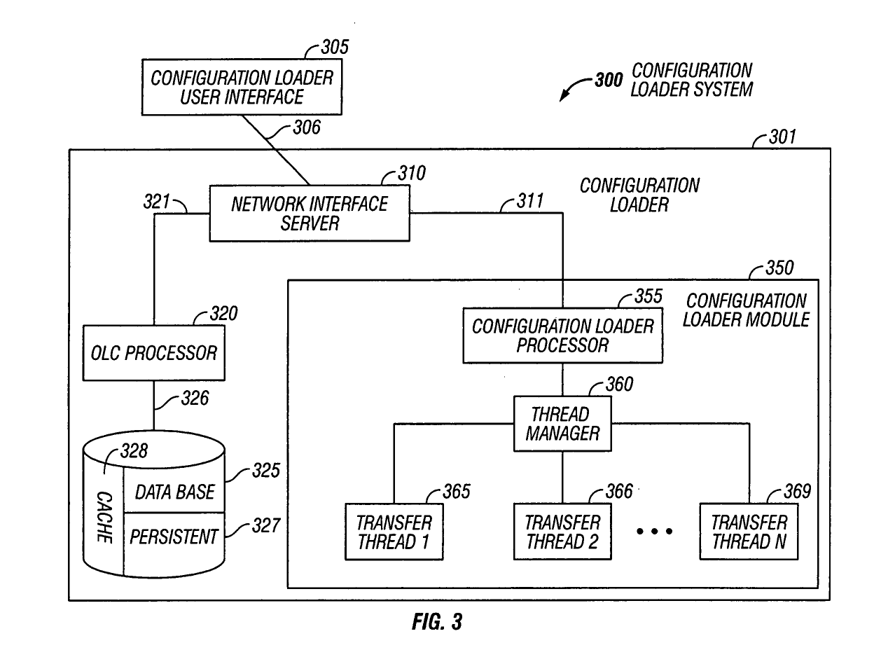

With reference to FIG. 3, a configuration loader system 300 that may be used to implement the present invention is described. The configuration loader system is responsible for loading or transferring logical and/or physical configurations from a source storage facility image (SFI) to a target SFI. The source SFI may be for example, an information storage and retrieval system configuration source. The target SFI may be for example, an information storage and retrieval system configuration target. The source or target system may be a physical system (i.e. systems 120, 130, 140) or a virtual system (i.e. a configuration stored in memory). Herein a source refers to an information storage and retrieval system configuration source and a target refers to an information storage and retrieval system configuration target.

In certain embodiments, configuration loader user interface 305 is used to allow a user to submit commands to configuration loader 301 by accepting configuration commands from a user or other source. In the preferred embodiment, the commands are sent asynchronously to configuration loader 301. After the command is sent, configuration loader 301 returns a message to the sender that the command is accepted or rejected. For example, if a command is sent to start a configuration transfer, configuration loader 301 accepts the command and returns a message to the user interface 305 indicating that the command is accepted. Configuration loader 301 may then process the command and simultaneously accept new commands. This capability allows user interface 305 to remain active (i.e. submit or receive commands and information) and not to have to wait until the first command completes before executing additional commands. In other embodiments, the commands may be transmitted synchronously. In certain embodiments, configuration loader interface 305 may be implemented on a separately network-connected computer system, such as a mainframe, personal computer, workstation, server and combinations thereof. In certain embodiments, configuration loader interface 305 may provide a graphical user interface (GUI), command line interface (CLI) or other system to allow a user to select and run configuration transfers or loads between source and target systems. In certain embodiments, configuration loader interface 305 may be implemented by user interface 160 (FIG. 1). Configuration loader interface 305 uses communication link 306 to communicate with configuration loader 301 via network interface server 310. Communication links 306, 321, 311 and 326, are independently selected from the group comprising a wireless communication link, a serial interconnection, such as RS-232 or RS-422, an ethernet interconnection, a SCSI interconnection, an iSCSI interconnection, a Gigabit Ethernet interconnection, a Bluetooth interconnection, a Fibre Channel interconnection, an ESCON interconnection, a FICON interconnection, a Local Area Network (LAN), a private Wide Area Network (WAN), a public wide area network, Storage Area Network (SAN), Transmission Control Protocol/Internet Protocol (TCP/IP), the Internet, and combinations thereof.

In certain embodiments, configuration loader 301 comprises network interface server 310, offline configuration processor (OLC) 320, database 325 and configuration loader module 350. Network interface server 310 provides a network connection for the components and provides the ability to perform configurations in a network-connected fashion so that users may start configuration transfers and disconnect without interrupting the transfers. The client-server design of configuration loader user interface 305 and configuration loader 301, respectively, along with the ability to send asynchronous commands to configuration loader 301 provides the ability to disconnect configuration loader interface 305 without interrupting any configuration transfer. Network interface server 310 communicates with configuration loader module 350 and OLC processor 320 via communication links 311 and 321.

OLC processor 320 interfaces with database 325 via communication link 326. OLC processor 320 and database 325 provide a repository for offline storage systems configuration. OLC processor 320 allows users to create virtual configuration images for modeling and pre-planning of their storage configuration images. OLC processor 320 maintains one or more virtual configurations in a database (i.e. database 325). OLC processor 320 also maintains a task list for configuration transfers. Herein, task list and list of tasks are used interchangeably with the same meaning. For example, if a source has a logical object (i.e. RAID Array) which needs to be transferred to a target, the configuration information that includes the object is stored in the database 325 as an offline configuration. Database 325 includes a cache 328 and persistent 327. In other embodiments, the OLC processor 320 may maintain the task list in cache memory 328. Cache memory 328 may be used for volatile fast storage of temporary data. Persistent 327 may provide nonvolatile long term storage of data. Both cache memory 328 or persistent 327, or combinations thereof, can be used to temporarily store incoming configuration object requests (i.e. adding/creating, deleting/removing, and/or modifying configuration objects) from configuration loader user interface 305 in offline configuration storage (325, 327, 328). For example, when configuration loader user interface 305 creates a logical object, such as a volume, in information storage and retrieval system 140, the volume could also be added to the offline configuration. The offline configuration could then be used as a cached copy of the actual configuration existent on information storage and retrieval system 140. This would reduce costly retrieval times for very large configurations when transferring the configuration from information storage and retrieval system 140 to a target system. The target system may be an offline or virtual configuration, of which the configuration already exists in the offline memory storage. The target system only needs to communicate with configuration loader user interface 305 to be used as a target. In another embodiment, the target may be a configuration transfer to another information storage and retrieval system.

Configuration loader module 350 is responsible for maintaining and providing controls access (i.e. start, cancel, etc.) to all configuration transfers. In certain embodiments, configuration loader module 350 comprises configuration loader processor 355, thread manager 360, and one or more transfer threads 365, 366-369. Configuration loader processor 355 provides interpretation and execution of configuration commands and reporting of the status of the system to/from configuration loader interface 305. In the preferred embodiment the status is reported asynchronously back to the user interface application running on configuration loader interface 305. Configuration loader processor 355 is also responsible for maintaining a list of all started, canceled, suspended and completed transfer threads. In certain embodiments one or more client users are using one or more configuration loader interfaces 305. Configuration loader processor 355 controls configuration requests received from the client users while maintaining the status of all configuration transfer operations. Configuration loader processor 355 may also maintain a list, in nonvolatile storage (i.e. database 325), of the ongoing configuration load operations. If a power failure or other error condition occurs, configuration loader module 350 has the capability to determine which operations haven't completed and restart the incomplete operations.

Thread manager 360 is responsible for maintaining all transfer threads. For each configuration transfer between a source and a target, configuration loader module 350 will spawn a single thread (i.e. threads 365-369) using configuration loader processor 355 and thread manager 360. For each configuration transfer, multiple threads may be spawned and exist at any time to apply the configuration source(s) to target information storage and retrieval system(s). There may be as many threads, or configuration transfers, at one time as memory allows. Thread manager 360 manages all currently active threads. The use of threads allows multiple configuration loads to occur simultaneously.

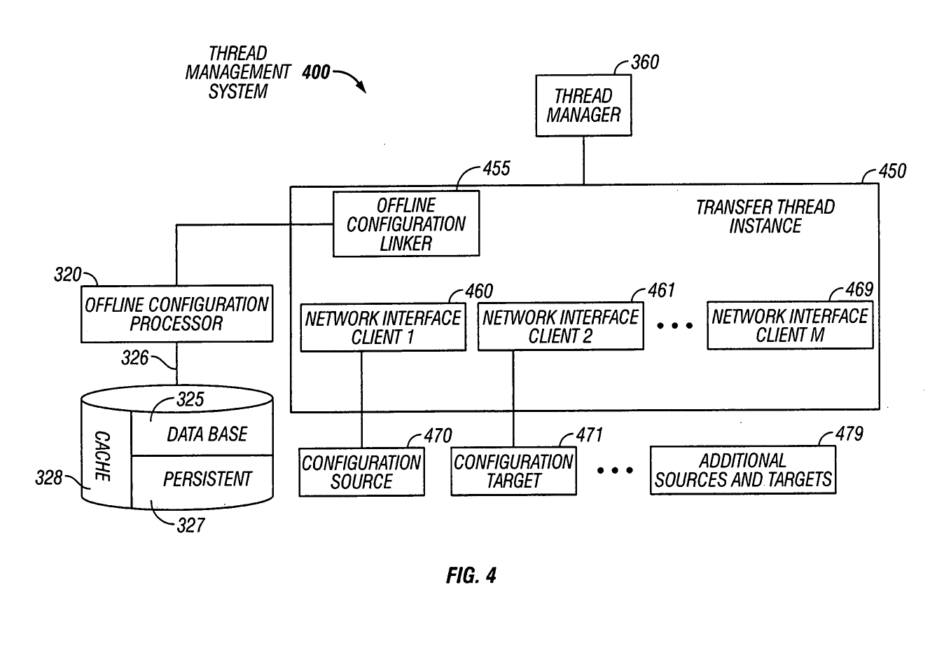

FIG. 4 shows one embodiment of a thread management system 400 for use with the present invention. In certain embodiments, each transfer thread (i.e. any one of transfer threads 365-369) spawned to execute a configuration transfer is a transfer thread instance 450. Transfer thread instance 450 connects a configuration source (i.e. configuration source 470) to a configuration target (i.e. configuration target 471) using, for example, one or more network interface clients 460-469. In the preferred embodiment, a configuration may be transferred from a single source to multiple targets (for example N targets; where N is the number of targets) by creating N transfer thread instances. Alternatively, a configuration may be transferred from a single source to multiple targets by using multiple source and target network interface clients (i.e. 460-469). In addition, transfer thread instance 450 connects to database 325 through offline configuration linker 455 and offline configuration processor 320. Database 325 provides persistently maintainable configuration storage (nonvolatile storage) of source configurations, a configuration task list and cached configurations. Offline configuration processor 320 has the ability to store more than one virtual configuration image of an information storage and retrieval system. Configuration loader 301 uses offline configuration processor 320 and database 325 to store a task list of items to be transferred from a configuration source (i.e. configuration source 470) to a configuration target (i.e. configuration target 471). The task list is built by loading a configuration image from a configuration source (and verifying each object for compatibility with the configuration target). As each configuration object completes its installation on the respective configuration target, the configuration object is then removed from the task list. If or when interruptions occur (i.e. power outage, or network interrupts), the configuration loader 301 is able to determine where the configuration process was interrupted because the task list is persistently maintained in the OLC database.

In certain embodiments, each transfer thread (i.e. any one of transfer threads 365-369) is a thread executing a configuration transfer while updating the status of the configuration transfer at significant checkpoints in the process. In the preferred embodiment, the thread is a ⁱJava™ thread. A significant checkpoint may be for example, 5% increments of progress or other user defined increments. Configuration loader 301 provides the ability to report status incrementally, at significant checkpoints; however, this capability does not have to be used to provide a configuration transfer. In certain embodiments, the configuration transfers and the respective status are maintained by Java objects. For example, each configuration transfer may be maintained within a single transfer Java object and each transfer object maintains a single status Java object. The transfer objects contain specific information about the transfers. The status objects are retrievable by the using applications executing on configuration loader user interface 305. The status objects provide methods to obtain the transfer's status. This allows using applications executing on configuration loader user interface 305 to report the status of the transfers to the users. For example, operative to a completion of the application of the configuration source to the target information storage and retrieval system, the configuration loader may communicate the status of one or more configuration transfers to the configuration loader user interface. The status of the transfer may comprise any type of statistical data about the transfers. For example, the amount of time to execute a transfer, a group of transfers, means, standard deviation, etc. for multiple transfers, the type of configuration objects transferred (i.e. ranks versus volumes), etc. Additionally, the status of any transfer complete or not may be obtained at any time.
ⁱ Java and all Java-based trademarks are the trademarks of Sun Microsystems, Inc. in the United States, other countries, or both.

In certain embodiments, each transfer thread creates at least two or more network interface client connections to a configuration source (i.e. configuration source 470) and to a configuration target (i.e. configuration target 471).

In certain embodiments, transferring configurations requires analyzing the physical configuration compatibility of the source and target. Before a configuration transfer can be accomplished, configuration loader 301 analyzes the source and target physical configurations to determine the physical configuration of the information storage and retrieval system configuration source and the physical configuration of the target information storage and retrieval system. Configuration loader 301 then determines if every physical object from the source has a physical counterpart on the target. If a counterpart does not exist then the transfer cannot occur because of a physical incompatibility. If the source and target are compatible then the configuration of the target may proceed by use of the Applicant's invention. In the preferred embodiment, configuration loader system 300 first verifies that each specified physical object exists on both the source and target. If all specified physical objects exist on both the source and target, the physical verification is complete and the process continues to perform a logical verification and then execute the transfer of the configuration. If the target does not contain the respective source physical object, then it is necessary to determine if a logical object needs to be transferred from the source to target within the respective physical location. If a logical object does not need to be transferred from the source to target within the respective physical location the process continues by examining the other physical objects. If a logical object does need to be transferred from the source to target within the respective physical location, verification fails and the configuration transfer does not proceed because of incompatibilities between the physical configurations. In the preferred embodiment, the physical verification is accomplished first before the logical verification/analysis may proceed.

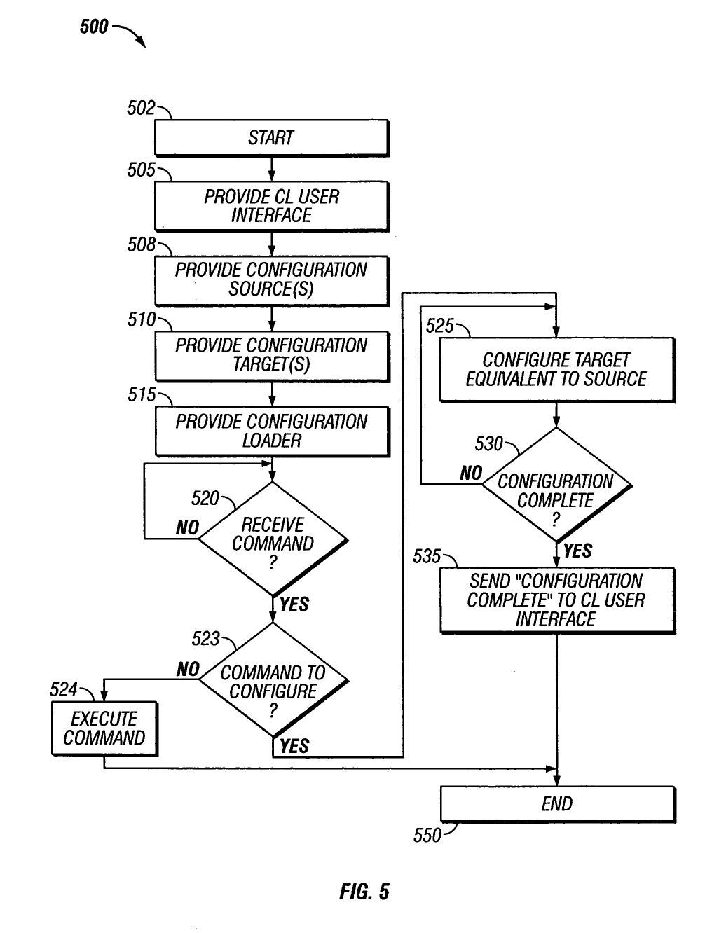

FIG. 5 summarizes certain initial steps of Applicant's method to configure information storage and retrieval systems. Referring now to FIG. 5, at step 505 the method provides a configuration loader user interface for accepting configuration commands. In the preferred embodiment, the configuration loader user interface provided may be configuration loader interface 305 described above. Configuration commands may comprise, for example, a transfer command to transfer a physical and/or logical configuration from a source to a target information storage and retrieval system. Configuration commands may additionally comprise commands to determine configurations, determine the status of a transfer, cancel a transfer, suspend a transfer, list completed transfers, list suspended transfers, list canceled transfers, list active transfers, list partial configurations, perform partial configuration transfers, resume an already started transfer or any other command needed for transferring configurations. The configuration loader user interface may accept configuration commands from a user, operator, computer system, etc.

At step 508 the method provides at least one information storage and retrieval system configuration source. An information storage and retrieval system configuration source may be a configuration maintained on, for example, any of systems 120 (FIG. 1), 130 (FIG. 1), 140 (FIG. 1). The configurations existing on the source may have been originally setup from a host computer (i.e. host(s) 105) over a network connection (i.e. network interface 180). Alternatively, the configuration could have been setup from user interface 160 through the master controller 110 and network interface 180, or combinations thereof. An information storage and retrieval system configuration source also may be a virtual or offline configuration maintained by OLC processor 320 and stored in database 325, or combinations thereof. Each configuration source is capable of communicating with configuration loader 301.

At step 510 the method provides at least one target information storage and retrieval system. A target information storage and retrieval system may comprise, for example, any of systems 120 (FIG. 1), 130 (FIG. 1), 140 (FIG. 1), a virtual or offline configuration maintained by OLC processor 320 to be stored in database 325, a configuration sent to configuration loader user interface 305 (FIG. 3), a configuration sent to a host computer (i.e. host(s) 105) a configuration sent over a network connection (i.e. network interface 180) or combinations thereof. Each configuration target is capable of communicating with configuration loader 301.

At step 515 the method provides a configuration loader capable of communicating with a configuration loader user interface, with an information storage and retrieval system configuration source and with a target information storage and retrieval system. The configuration loader comprises a configuration loader module and a database. In the preferred embodiment, the configuration loader may be, for example, configuration loader 301 described above. The configuration loader communicates with the configuration loader user interface, with an information storage and retrieval system configuration source and with a target information storage and retrieval system using, for example, network interface server 310 as described above. The configuration loader uses any of network interface clients 460-469 for communication with an information storage and retrieval system configuration source and with a target information storage and retrieval system. The configuration loader module for configuring the target information storage and retrieval system may be, for example, configuration loader module 350 described above. The database may be, for example, database 325, persistent 327, and cache 328 or combinations thereof. In the preferred embodiment, offline configuration processor 320 is used to store/retrieve information with respect to the database. Offline configuration processor 320 could be any application that is capable of managing at least one or more virtual or offline storage configurations. In the preferred embodiment, the database may be consist of any common database application program, such as DB2, Oracle, the like, or combinations thereof.

At step 520 the method provides a loop to wait for a configuration command. As described above, configuration commands may additionally comprise commands to determine configurations, determine the status of a transfer, cancel a transfer, suspend a transfer, list completed transfers, or any other command needed for transferring configurations. If a command is received, then control flow to step 523.

At step 523 the method provides a decision to determine if the command received is to configure a target information storage and retrieval system using a configuration source. If the command received is not to configure a target information storage and retrieval system using a configuration source, then control flows to step 524 to execute the command. The command executed at step 524 may comprise commands to determine configurations, determine the status of a transfer, cancel a transfer, suspend a transfer, list completed transfers, or any other command needed for transferring configurations as described above. After execution of step 524, control flows to step 550 to end.

If at step 523, the command received is a command to configure a target information storage and retrieval system, then control flows to step 525 where configuration loader module 350 configures the target information storage and retrieval system to be equivalent to the configuration source. Execution of steps 523 and 525 may be accomplished by Applicants' system described above. For example, (1c) operative to configuration loader 301 receiving a command from configuration loader user interface 305 to configure a target information storage and retrieval system using a configuration source, configuration loader module 350 configures the target information storage and retrieval system to be equivalent to the configuration source. In the preferred embodiment, a command to configure is received from configuration loader user interface 305, however a command may also be received from other sources, for example, from an information storage and retrieval system (i.e. any of systems 120, 130, 140), OLC processor 320, a host computer (i.e. host(s) 105), a network connection (i.e. network interface 180) or combinations thereof.

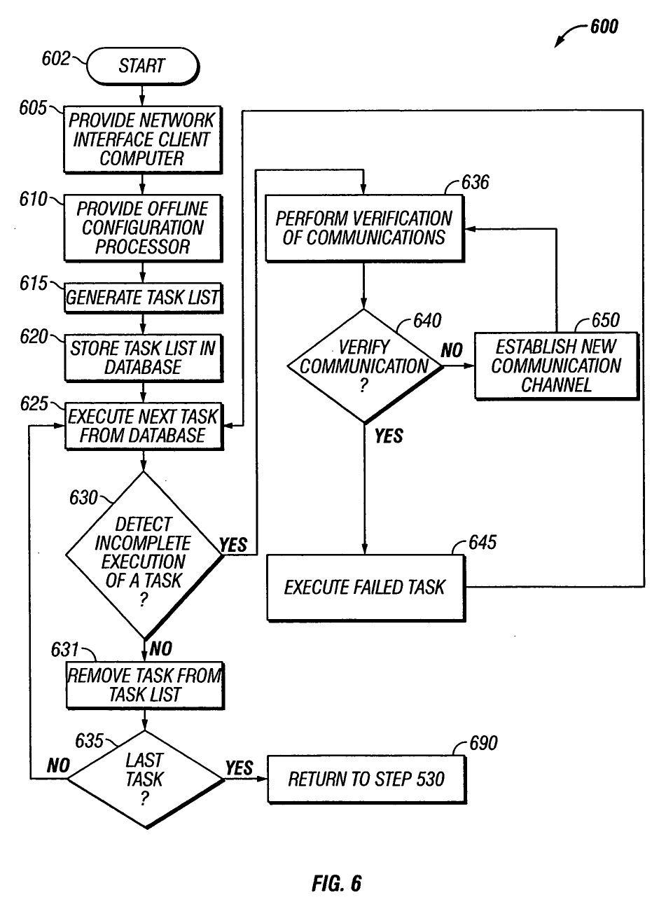

The configuration of the target information storage and retrieval system to be equivalent to the configuration source at step 525 may be accomplished by the application of the configuration source to the target information storage and retrieval system. In the preferred embodiment, thread management system 400 shown in FIG. 4 and described above is used to apply the configuration source to the target. In the preferred embodiment, step 525 is accomplished by process 600 shown in FIG. 6 and described below.

After execution of step 525, control flows to step 530 to determine if the configuration is complete. Operative to the completion of the application of the configuration source to the target information storage and retrieval system, the configuration loader communicates to the configuration loader user interface the completion of the application of the configuration source to the target information storage and retrieval system. If at step 530 it is determined that the configuration is complete then control transfers to step 535 to send a message to configuration loader user interface 305 that the configuration is complete. In certain embodiments, completion of the application of the configuration source to the target information storage and retrieval system may comprise a partial configuration of the target. This may occur when the configuration loader module applies the configuration source to the target information storage and retrieval system in a way to produce a partial configuration of the target information storage and retrieval system. Partial configuration transfers may be accomplished by transferring only a subset of configuration objects from the source to target. A partial configuration may be, for example, to transfer only four ranks (and the respective logical volumes) to a target from a total of eight ranks from the source. Partial configuration may be the result of interactive communication with configuration loader user interface 305 during the configuration process. After execution of step 535, control flows to step 550 where the process ends.

In the preferred embodiment the execution of step 525 for the configuration of the target information storage and retrieval system to be equivalent to the configuration source may be accomplished by process 600 shown in FIG. 6. Process 600 begins by providing a network interface client computer capable of communicating with the information storage and retrieval system configuration source and the configuration loader at step 605. The network interface client computer may be, for example, network interface client 460 (FIG. 4). The configuration source may be, for example, configuration source 470 (FIG. 4). The configuration loader may be, for example, configuration loader 301 (FIG. 4). As described above with reference to FIG. 4, each transfer thread (i.e. any one of transfer threads 365-369) spawned to execute a configuration transfer may be a transfer thread instance 450. In the preferred embodiment, transfer thread instance 450 connects a configuration source (i.e. configuration source 470) to configuration loader 301, using, for example, a network interface client(s) (i.e. 460-469). Once a source and configuration loader 301 are connected the configuration may proceed under the direction of, for example, transfer thread instance 450 to execute steps to accomplish the configuration. In addition to connecting the sources and targets, the threads may also establish a private link/connection to OLC processor 320 and database 325. As described above, database 325 is used to store a task list to accomplish the configuration transfer.

At step 610, an offline configuration processor (i.e. offline configuration processor 320) capable of communicating with database 325 and configuration loader module 350 is provided. As described above, offline configuration processor 320 provides access to configuration data, task lists and other relevant data for configurations.

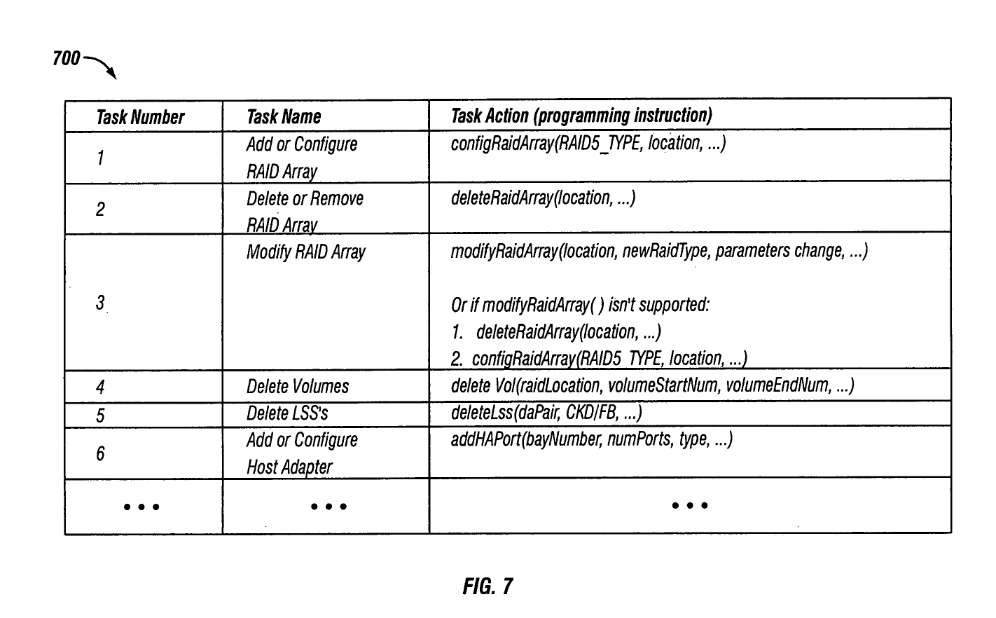

At step 615, configuration loader module 350 generates a list of tasks necessary to configure the target information storage and retrieval system to be equivalent to the information storage and retrieval system configuration source. In the preferred embodiment, the task list is constructed from an analysis of the physical and/or logical configurations of the source and target. The task list may comprise a list of tasks to execute to configure the target to have logical objects and/or physical objects that are equivalent to the source. In the preferred embodiment, the tasks are the configuration instructions specifying configuration actions to execute on the target to produce a target configuration to be equivalent to the source configuration. The configuration instructions may add, delete, and/or modify configuration objects on the target. Each instruction contains the necessary parameters to add, delete, or modify configuration objects. FIG. 7 shows an example of a list of tasks 700, that may be used to configure a target. FIG. 7 shows only an example and is not meant to be a complete list. The first column of list of tasks 700 is an arbitrary task number. The second column is a task name. The third column is the task action. For example, the first task name is “add or configure a RAID array”. The first task action listed in 700 is an example of a programming instruction to configure a RAID 5 array at a location (i.e. a physical location on the target). The task list may be organized and maintained in a variety of different ways, to result in a list of tasks, instructions, actions, the like, or combinations thereof, that are necessary to perform on the target information storage and retrieval system so that the configuration of the target is the same as the configuration of the information storage and retrieval system source. In the preferred embodiment, the task list is persistently maintained in an offline configuration database (i.e. database 325, 327, 328). Each of the configuration actions may be a task. The tasks may add, remove or modify logical objects at the target. OLC processor 320 and database 325 may be used to retrieve and store logical objects for either the source or target. In the preferred embodiment, a configuration of logical objects is created and stored in database 325 by OLC processor 320 that represents the source configuration. Configuration loader 301 by use of the task list (or other means) transfers the source configuration stored in database 325 to the target. Each task in the task list may represent the removal, addition or modification of a logical object. Each task is removed from the task list upon completion. If an adverse condition is experienced resulting in the halting of a transfer, then configuration loader 301 will automatically attempt to reconnect with the source and target and resume the transfer using the task list, from the point where the transfer was halted.

At step 620, configuration loader module 350 stores the list of tasks in database 325. Configuration loader module 350 may store the list of tasks in a persistent database (i.e. persistent database 327). The tasks are stored through the Offline Configuration Linker 455. Configuration loader 301 determines what tasks are necessary to accomplish the transfer. Each task is then sent to offline configuration processor 320 through offline configuration linker 455. Linker 455 provides a direct and private connection to offline configuration processor 320. In an alternative embodiment, the tasks may be sent to offline configuration processor 320 through any other means. The task that is sent to offline configuration processor 320 may then be persistently stored in the database 325.

At step 625, configuration loader module 350 configures the target information storage and retrieval system by executing the list of tasks. After the analysis of the source and target logical configurations, the generated task list contains the necessary configuration actions required to configure the target with the same configuration as the source. In one embodiment, configuration loader module 350 then configures the target information storage and retrieval system by retrieving each task of the list of tasks from database 325 using offline configuration processor 320. At step 631, each task is removed from the list of tasks stored in the database upon completion of execution of each task. The process continues until all tasks in the task list are executed and removed from the task list.

For each task in the task list, step 630 is executed to determine if each task executed completely and if not then the communication channel with the source and/or the target is verified. For example, operative to configuration loader 301 detecting an incomplete execution of failed task, step 636 is executed to begin the communication verification process. An incomplete execution of failed task may be caused by, for example, a power outage. The power outage may cause a communication problem between configuration loader system 300, a source, a target or combinations thereof. If the power outage causes a communication problem between configuration loader system 300, a source, a target or combinations thereof, then the failed task may most likely be executed after establishing the communications between the affected components. In certain circumstances the power outage may cause a failure of configuration loader system 300, if for example, the power is removed from the computer system where configuration loader system 300, or any one of configuration loader system's 300 components are running on. In this case, when configuration loader system 300 loses power, configuration loader system 300 may require a system reboot to restore operation of configuration loader system 300 or components. Upon completing the reboot, configuration loader system 300 may first determine if the task list stored in the database (i.e. database 325, 327, 328) contains any unexecuted failed tasks, any unexecuted tasks and/or outstanding configuration transfers. If there are remaining tasks to execute then step 636 is executed to begin the communication verification process, and then execute the next task in the task list. This robust design enables the capability to recover from any error condition by examining the task list after any error condition and then executing the task following the last successful task executed. Multiple task lists may be executing simultaneously and upon encountering an error the system will automatically begin operation at the correct place to complete one or more configuration transfer. An incomplete execution of failed task may be caused by other error conditions with any of the components of configuration loader system 301, sources, targets, host computers, etc. or combinations thereof. An incomplete execution of a failed task may occur when a task retrieved from the task list begins executing and then encounters an error condition that results in a failure in the execution of the task. For example, a failed task may occur when a task that configures a logical object on a target is interrupted by a communication problem with the target. Upon encountering a failed task, it is necessary to verify communication with sources and/or targets before attempting to execute the failed task again.

At step 636, configuration loader 301 performs a verification of communications necessary for the configuration loader operation. The communications necessary for the configuration loader operation may be communications between configuration loader 301 and a source, a target, a host computer, and/or any other component necessary for configuration loader 301 operation. Step 636 may be accomplished by, for example, configuration loader 301 sending test messages to sources, targets and/or other necessary components and then examining the responses to determine if the communication is operating properly.

Execution of step 630 with a “no” result transfers control to step 631. At step 631, the current task that completed executing is removed from the task list. Step 635 is executed after step 631.

At step 635, the current task that completed executing is examined to determine if it is the last task to be executed from the task list. If the current task is the last task to be executed then control transfers to step 690 to return to step 530 (FIG. 5). If the current task is not the last task to be executed then control transfers to step 625 to execute the next task in the task list.

After execution of step 636, step 640 is executed to determine if the verification of communications necessary for the configuration loader operation is complete. Operative to configuration loader 301 successfully verifying the communications necessary for configuration loader 301 operation, step 645 is executed. At step 645, configuration loader module 350 executes the list of tasks beginning with the failed task. After execution of step 645, control transfers to step 625 to execute any remaining tasks.

A failure may occur in the communications with a source and/or a target. If at step 640, configuration loader 301 cannot successfully verify the communications necessary for configuration loader 301 operation with a source, then step 650 is executed to establish a new communication channel. At step 605 a first network interface client computer capable of communicating with an information storage and retrieval system configuration source and configuration loader 301 was provided. Configuration loader 301 established communication with the information storage and retrieval system source using the first network interface client computer to communicate configuration information with respect to the information storage and retrieval system source. Operative to configuration loader 301 detecting an incomplete execution of failed task caused by a communication problem with the information storage and retrieval system source, configuration loader 301 reestablishes communication with the information storage and retrieval system source using the first network interface client computer. After reestablishing communication with the information storage and retrieval system source, at step 650, step 636 is executed again to allow configuration loader 301 to perform a verification of communications necessary for configuration loader 301 operation. Operative to configuration loader 301 successfully verifying communications necessary for configuration loader 301 operation using the first network interface client computer at step 640, configuration loader 301 executes the list of tasks beginning with the failed task.

If at step 640 or 650, configuration loader 301 cannot successfully verify the communications necessary for configuration loader 301 operation with the first network interface client computer, then a second network interface client computer capable of communicating with an information storage and retrieval system configuration source and configuration loader 301 is provided. Configuration loader 301 establishes communication with the information storage and retrieval system source using the second network interface client computer to communicate configuration information with respect to the information storage and retrieval system source. After establishing communication with the information storage and retrieval system source, at step 650, step 636 is executed again to allow configuration loader 301 to perform a verification of communications necessary for configuration loader 301 operation using the second network interface client computer. Operative to configuration loader 301 successfully verifying communications necessary for configuration loader 301 operation using the second network interface client computer at step 640, configuration loader executes the list of tasks beginning with the failed task.

A failure may also occur in the communications with a target. If at step 640, configuration loader 301 cannot successfully verify the communications necessary for configuration loader 301 operation with a target, then step 650 is executed to establish a new communication channel. At step 605 a first network interface client computer capable of communicating with a target information storage and retrieval system and configuration loader 301 was provided. Configuration loader 301 established communication with the target information storage and retrieval system using the first network interface client computer to communicate configuration information with respect to the target information storage and retrieval system. Operative to configuration loader 301 detecting an incomplete execution of failed task caused by a communication problem with the target information storage and retrieval system, configuration loader 301 re-establishes communication with the target information storage and retrieval system using the first network interface client computer. After reestablishing communication with the target information storage and retrieval system, at step 650, step 636 is executed again to allow configuration loader 301 to perform a verification of communications necessary for configuration loader 301 operation. Operative to configuration loader 301 successfully verifying communications necessary for configuration loader 301 operation using the first network interface client computer at step 640, configuration loader 301 executes the list of tasks beginning with the failed task.

If at step 640 or 650, configuration loader 301 cannot successfully verify the communications necessary for configuration loader 301 operation with the first network interface client computer, then a second network interface client computer capable of communicating with the target information storage and retrieval system and configuration loader 301 is provided. Operative to configuration loader 301 detecting an incomplete execution of failed task caused by a communication problem with the target information storage and retrieval system source, configuration loader 301 establishes communication with the information storage and retrieval system source using the second network interface client computer to communicate configuration information with respect to the target information storage and retrieval system. After establishing communication with the target information storage and retrieval system, at step 650, step 636 is executed again to allow configuration loader 301 to perform a verification of communications necessary for configuration loader 301 operation. Operative to configuration loader 301 successfully verifying communications necessary for configuration loader 301 operation using the second network interface client computer at step 640, configuration loader executes the list of tasks beginning with the failed task.

In certain embodiments, the operation of the present invention may be accomplished by master controller 110, on a separately network-connected computer system, such as a mainframe, personal computer, workstation, one or more of the information storage and retrieval systems, server and combinations thereof. In still other embodiments, the operation of the present invention may be accomplished by the manufacturer of the master controller, and firmware encoding disposed in a controller, such as processor 112 (FIG. 1).

In certain embodiments, the operation of the present invention may be accomplished by providing a client computer system for operation of configuration loader user interface 305 and providing a server computer system in communication with the client computer system for operation of configuration loader 301. The client and/or server computer systems may comprise a host computer, a mainframe computer, personal computer, workstation, and combinations thereof, including an operating system such as Windows, AIX, Unix, MVS, LINUX, etc. (Windows is a registered trademark of Microsoft Corporation; AIX is a registered trademark and MVS is a trademark of IBM Corporation; and UNIX is a registered trademark in the United States and other countries licensed exclusively through The Open Group.) The client and/or computer systems may reside or be part of host(s) 105, client(s) 460-469, server 310, storage controller(s) 120-140, or any other computing system connected to or associated with data processing system 100.

In certain embodiments, an online storage controller is used as an information storage and retrieval system configuration source. For example, any of storage controllers 120, 130 and/or 140 (FIG. 1) operating online, may be used as a configuration source 470 (FIG. 4). A storage controller that is online is a storage controller that is currently operating by performing data processing operations. An online storage controller may be performing I/O operations with respect to one or more host computer systems, one or more primary or secondary storage devices and/or data cache.

In other embodiments, an offline storage controller is used as an information storage and retrieval system configuration source. For example, any of storage controllers 120, 130 and/or 140 (FIG. 1) operating offline, may be used as a configuration source 470 (FIG. 4). A storage controller that is offline is a storage controller that is not currently operating and not performing data processing operations. An offline storage controller may be in a quiesce state and not performing I/O operations with respect to one or more host computer systems, one or more primary or secondary storage devices and/or data cache. Alternatively, and in the preferred embodiment, an offline storage controller is an application program running on any computing device (i.e. host, server, PC, etc.) that simulates the configuration of a storage controller (i.e. systems 120,130,140). The offline storage controller may have the same configuration interface as any other storage controller's configuration interface. The offline storage controller may operate as an integrated tool that stores configuration images for more than one system or enterprise.

In certain embodiments, an online storage controller is used as a target information storage and retrieval system. For example, any of storage controllers 120, 130 and/or 140 (FIG. 1) operating online, may be used as configuration target 471 (FIG. 4). A storage controller that is online is a storage controller that is currently operating by performing data processing operations. An online storage controller may be performing I/O operations with respect to one or more host computer systems, one or more primary or secondary storage devices and/or data cache.

In other embodiments, an offline storage controller is used as a target information storage and retrieval system. For example, any of storage controllers 120, 130 and/or 140 (FIG. 1) operating offline, may be used as a configuration target 471 (FIG. 4). A storage controller that is offline is a storage controller that is not currently operating and not performing data processing operations. An offline storage controller may be in a quiesce state and not performing I/O operations with respect to one or more host computer systems, one or more primary or secondary storage devices and/or data cache. Alternatively, and in the preferred embodiment, an offline storage controller is an application program running on any computing device (i.e. host, server, PC, etc.) that simulates the configuration of a storage controller (i.e. systems 120,130,140). The offline storage controller may have the same configuration interface as any other storage controller's configuration interface. The offline storage controller may operate as an integrated tool that stores configuration images for more than one system or enterprise.

In the operation of the present invention, Applicant's master controller receives a request, or a command, or instructions (collectively a “request”) to configure a designated second information storage and retrieval system, i.e. a “target” system, with reference to a designated first information storage and retrieval system, i.e. the “source” system. In certain embodiments, the target system comprises an extant system, such as for example, one or more of systems 120 (FIG. 1), 130 (FIG. 1), and/or 140 (FIG. 1). In other embodiments, the target system comprises a virtual configuration image. In certain of these virtual system embodiments, the target system will be used as a simulation tool to assist the optimization of extant systems.

In certain embodiments, Applicant's invention includes instructions, where those instructions are executed by processor 112 (FIG. 1) to perform steps recited in the flowcharts shown in FIGS. 5-6.

In other embodiments, Applicant's invention includes instructions residing in any other computer program product, where those instructions are executed by a computer external to, or internal to, master controller 110. In either case, the instructions may be encoded in an information storage medium comprising, for example, a magnetic information storage medium, an optical information storage medium, an electronic information storage medium, and the like. By “electronic storage media,” Applicants mean, for example, a device such as a PROM, EPROM, EEPROM, Flash PROM, compactflash, smartmedia, and the like.

The foregoing description, for purposes of explanation, used specific nomenclature to provide a thorough understanding of the present invention. However, it will be apparent to one skilled in the art that the specific details are not required in order to practice the present invention. In other instances, well known circuits and devices are shown in block diagram form in order to avoid unnecessary distraction from the present invention. Thus, the foregoing descriptions of specific embodiments of the present invention are presented for purposes of illustration and description. They are not intended to be exhaustive or to limit the present invention to the precise forms disclosed. Obviously many modifications and variations are possible in view of the above teachings.

The present invention disclosed herein may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium (e.g., magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, MRAMs, MEMS based memory, microcode, programmable logic, etc.). Code in the computer readable medium is accessed and executed by one or more processors. The code may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Of course, those skilled in the art will recognize that many modifications may be made to this configuration without departing from the scope of the present invention, and that the article of manufacture may comprise any information bearing medium known in the art.

The present invention disclosed herein may be implemented as a method for deploying computing infrastructure by integrating computer readable code into a system to configure information storage and retrieval systems. Computing infrastructure is the hardware, software, cables, power distribution, or any other components necessary for system operation. The computing infrastructure may be deployed by a service provider, hardware supplier, third party, business entity, etc. or combinations thereof. A customer may be billed and pay for the deployment of the computing infrastructure. The computer readable code in combination with the system to configure information storage and retrieval systems is capable of generating a list of tasks necessary to configure a target information storage and retrieval system to be equivalent to an information storage and retrieval system configuration source, storing the list of tasks in a database and configuring the target information storage and retrieval system by executing the list of tasks. The code in combination with the system to configure information storage and retrieval systems is further capable of storing the list of tasks in a persistent database. The code in combination with the system to configure information storage and retrieval systems is further capable of retrieving each task of the list of tasks from the database and removing each task from the list of tasks stored in the database upon completion of execution of each task. The code in combination with the system to configure information storage and retrieval systems is further capable of operations that provide for operative to detecting an incomplete execution of a failed task: performing a verification of communications necessary for a configuration loader operation; and operative to the configuration loader successfully verifying the communications necessary for the configuration loader operation, executing the list of tasks beginning with the failed task.

The logic of FIGS. 5-6 describes specific operations occurring in a particular order. In alternative implementations, certain of the logic operations may be performed in a different order, modified or removed. Moreover, steps may be added to the above described logic and still conform to the described implementations. Further, operations described herein may occur sequentially or certain operations may be processed in parallel, or operations described as performed by a single process may be performed by distributed processes.

The logic of FIGS. 5-6 was described as being implemented in software. This logic may be part of the operating system of the host systems or an application program. In yet further implementations, this logic may be maintained in storage areas managed by the control units or in a read only memory or other hardwired type of device. The preferred logic may be implemented in hard disk drives or in programmable and non-programmable gate array logic.

The embodiments were chosen and described in order to best explain the principles of the present invention and its practical applications, to thereby enable others skilled in the art to best utilize the present invention and various embodiments with various modifications as are suited to the particular use contemplated. It is intended that the scope of the present invention be defined by the following claims and their equivalents.

What is claimed is:

1. A method to configure information storage and retrieval systems, comprising:
providing a configuration loader user interface for accepting configuration commands;
providing a configuration loader capable of communicating with said configuration loader user interface, with at least one information storage and retrieval system configuration source and with at least one target information storage and retrieval system,
said configuration loader comprising a configuration loader module and at least one database:
operative to said configuration loader receiving a command from said configuration loader user interface to configure said at least one target information storage and retrieval system to be equivalent to said at least one configuration source:
said configuration loader module generating a list of tasks necessary to said configure said at least one target information storage and retrieval system to be equivalent to said at least one information storage and retrieval system configuration source;
said configuration loader module storing said list of tasks in said at least one database; and
said configuration loader module configuring said at least one target information storage and retrieval system by executing said list of tasks.

2. The method of claim 1, further comprising:
providing said at least one information storage and retrieval system configuration source; and
providing said at least one target information storage and retrieval system.

3. The method of claim 1, where said step of providing a configuration loader further comprises:
said configuration loader module storing said list of tasks in a persistent database.

4. The method of claim 1, further comprising:
providing an offline configuration processor capable of communicating with said at least one database and said configuration loader module and where said step of said configuration loader module configuring said at least one target information storage and retrieval system by executing said list of tasks further comprises:
said configuration loader module retrieving each task of said list of tasks from said at least one database using said offline configuration processor; and
said configuration loader module removing said each task from said list of tasks stored in said at least one database upon completion of execution of said each task.

5. The method of claim 4, further comprising:
operative to said configuration loader detecting an incomplete execution of a failed task:
said configuration loader performing a verification of communications necessary for said configuration loader operation;
operative to said configuration loader successfully verifying said communications necessary for said configuration loader operation:
said configuration loader module executing said list of tasks beginning with said failed task.

6. The method of claim 5, wherein said incomplete execution of a failed task is caused by a power outage.

7. The method of claim 1, further comprising:
providing a first network interface client computer capable of communicating with said at least one information storage and retrieval system configuration source and said configuration loader;
said configuration loader establishing communications with said at least one information storage and retrieval system source using said first network interface client computer to communicate configuration information with respect to said at least one information storage and retrieval system source;
operative to said configuration loader detecting an incomplete execution of a failed task caused by a communication problem with said at least one information storage and retrieval system source:
said configuration loader reestablishing communication with said at least one information storage and retrieval system source using said first network interface client computer;
said configuration loader performing a verification of communications necessary for said configuration loader operation; and
operative to said configuration loader successfully verifying said communications necessary for said configuration loader operation using said first network interface client computer:
said configuration loader executing said list of tasks beginning with said failed task.

8. The method of claim 7, further comprising:
operative to said configuration loader not successfully verifying said communications necessary for said configuration loader operation using said first network interface client computer:
providing a second network interface client computer capable of communicating with said at least one information storage and retrieval system configuration source and said configuration loader;
said configuration loader establishing communications with said at least one information storage and retrieval system source using said second network interface client computer to communicate configuration information with respect to said at least one information storage and retrieval system source;
said configuration loader performing a verification of communications necessary for said configuration loader operation using said second network interface client computer; and
operative to said configuration loader successfully verifying communications necessary for said configuration loader operation using said second network interface client computer:
said configuration loader executing said list of tasks beginning with said failed task.

9. The method of claim 1, further comprising:
providing a first network interface client computer capable of communicating with said at least one target information storage and retrieval system and said configuration loader;
said configuration loader establishing communications with said at least one target information storage and retrieval system using said first network interface client computer to communicate configuration information with respect to said at least one target information storage and retrieval system;
operative to said configuration loader detecting an incomplete execution of a failed task caused by a communication problem with said at least one target information storage and retrieval system:
said configuration loader reestablishing communication with said at least one target information storage and retrieval system using said first network interface client computer;
said configuration loader performing a verification of communications necessary for said configuration loader operation; and
operative to said configuration loader successfully verifying said communications necessary for said configuration loader operation using said first network interface client computer:
said configuration loader executing said list of tasks beginning with said failed task.

10. The method of claim 9, further comprising:
operative to said configuration loader not successfully verifying said communications necessary for said configuration loader operation using said first network interface client computer:
providing a second network interface client computer capable of communicating with said at least one target information storage and retrieval system and said configuration loader;
said configuration loader establishing communications with said at least one target information storage and retrieval system using said second network interface client computer to communicate configuration information with respect to said at least one target information storage and retrieval system;
said configuration loader performing a verification of said communications necessary for said configuration loader operation using said second network interface client computer; and
operative to said configuration loader successfully verifying communications necessary for said configuration loader operation using said second network interface client computer:
said configuration loader executing said list of tasks beginning with said failed task.

11. A system to configure information storage and retrieval systems, comprising:
a configuration loader user interface for accepting configuration commands; and
a configuration loader capable of communicating with said configuration loader user interface, with at least one information storage and retrieval system configuration source and with at least one target information storage and retrieval system, said configuration loader comprising a configuration loader module and at least one database.

12. The system of claim 11, where said configuration loader is adapted to execute steps comprising:
operative to said configuration loader receiving a command from said configuration loader user interface to configure said at least one target information storage and retrieval system to be equivalent to said at least one configuration source:
said configuration loader module generating a list of tasks necessary to configure said at least one target information storage and retrieval system to be equivalent to said at least one information storage and retrieval system configuration source;
said configuration loader module storing said list of tasks in said at least one database; and
said configuration loader module configuring said at least one target information storage and retrieval system by executing said list of tasks.

13. The system of claim 12, further comprising a persistent database for storing said list of tasks.

14. The system of claim 12, further comprising:
an offline configuration processor capable of communicating with said at least one database and said configuration loader module and where said step of said configuration loader module configuring said at least one target information storage and retrieval system by executing said list of tasks further comprises:
said configuration loader module retrieving each task of said list of tasks from said at least one database using said offline configuration processor; and
said configuration loader module removing said each task from said list of tasks stored in said at least one database upon completion of execution of said each task.

15. The system of claim 12, where said configuration loader is adapted to execute steps further comprising:
operative to said configuration loader detecting an incomplete execution of a failed task:
said configuration loader performing a verification of communications necessary for said configuration loader operation; and
operative to said configuration loader successfully verifying said communications necessary for said configuration loader operation:
said configuration loader module executing said list of tasks beginning with said failed task.

16. The system of claim 12, further comprising:
a first network interface client computer capable of communicating with said at least one information storage and retrieval system configuration source and said configuration loader and where said configuration loader is adapted to execute steps comprising:
said configuration loader establishing communication with said at least one information storage and retrieval system source using said first network interface client computer to communicate configuration information with respect to said at least one information storage and retrieval system source;
operative to said configuration loader detecting an incomplete execution of a failed task caused by a communication problem with said at least one information storage and retrieval system source:
said configuration loader reestablishing communication with said at least one information storage and retrieval system source using said first network interface client computer;
said configuration loader performing a verification of communications necessary for said configuration loader operation; and
operative to said configuration loader successfully verifying said communications necessary for said configuration loader operation using said first network interface client computer:
said configuration loader executing said list of tasks beginning with said failed task.

17. The system of claim 16, further comprising:
a second network interface client computer capable of communicating with said at least one information storage and retrieval system configuration source and said configuration loader and where said configuration loader is adapted to execute steps further comprising:
operative to said configuration loader not successfully verifying said communications necessary for said configuration loader operation using said first network interface client computer:
said configuration loader establishing communication with said at least one information storage and retrieval system source using said second network interface client computer to communicate configuration information with respect to said at least one information storage and retrieval system source;
said configuration loader performing a verification of said communications necessary for said configuration loader operation using said second network interface client computer; and
operative to said configuration loader successfully verifying said communications necessary for said configuration loader operation using said second network interface client computer:
said configuration loader executing said list of tasks beginning with said failed task.

18. The system of claim 12, further comprising:
a first network interface client computer capable of communicating with said at least one target information storage and retrieval system and said configuration loader and where said configuration loader is adapted to execute steps comprising:
said configuration loader establishing communication with said at least one target information storage and retrieval system using said first network interface client computer to communicate configuration information with respect to said at least one target information storage and retrieval system;
operative to said configuration loader detecting an incomplete execution of a failed task caused by a communication problem with said at least one target information storage and retrieval system:
said configuration loader reestablishing communication with said at least one target information storage and retrieval system using said first network interface client computer;
said configuration loader performing a verification of communications necessary for said configuration loader operation; and
operative to said configuration loader successfully verifying said communications necessary for said configuration loader operation using said first network interface client computer:
said configuration loader executing said list of tasks beginning with said failed task

19. The system of claim 18, further comprising:
a second network interface client computer capable of communicating with said at least one target information storage and retrieval system and said configuration loader and where said configuration loader is adapted to execute steps further comprising:
operative to said configuration loader not successfully verifying said communications necessary for said configuration loader operation using said first network interface client computer:
said configuration loader establishing communication with said at least one target information storage and retrieval system using said second network interface client computer to communicate configuration information with respect to said at least one target information storage and retrieval system;
said configuration loader performing a verification of said communications necessary for said configuration loader operation using said second network interface client computer; and
operative to said configuration loader successfully verifying said communications necessary for said configuration loader operation using said second network interface client computer:
said configuration loader executing said list of tasks beginning with said failed task.

20. The system of claim 11, where said configuration loader module comprises a configuration loader processor for execution of said configuration commands and a thread manager for managing one or more transfer threads to accomplish one or more configuration transfers.

21. An article of manufacture comprising a data storage medium tangibly embodying a program of machine-readable instructions executable by a system to configure information storage and retrieval systems, said system comprising:
a configuration loader user interface for accepting configuration commands;
a configuration loader capable of communicating with said configuration loader user interface, with at least one information storage and retrieval system configuration source and with at least one target information storage and retrieval system, said configuration loader comprising a configuration loader module and at least one database, where said program of machine-readable instructions causes:
operative to said configuration loader receiving a command from said configuration loader user interface to configure said at least one target information storage and retrieval system to be equivalent to said at least one configuration source:
said configuration loader module generating a list of tasks necessary to configure said at least one target information storage and retrieval system to be equivalent to said at least one information storage and retrieval system configuration source;
said configuration loader module storing said list of tasks in said at least one database; and
said configuration loader module configuring said at least one target information storage and retrieval system by executing said list of tasks.

22. The article of manufacture of claim 21 where said program of machine-readable instructions further causes said configuration loader module to store said list of tasks in a persistent database.

23. The article of manufacture of claim 21, wherein said system further comprises an offline configuration processor capable of communicating with said at least one database and said configuration loader module and where said step of said configuration loader module configuring said at least one target information storage and retrieval system by executing said list of tasks further comprises:
said configuration loader module retrieving each task of said list of tasks from said at least one database using said offline configuration processor; and
said configuration loader module removing said each task from said list of tasks stored in said at least one database upon completion of execution of said each task.

24. The article of manufacture of claim 21 where said program of machine-readable instructions further causes:
operative to said configuration loader detecting an incomplete execution of a failed task:
said configuration loader performing a verification of communications necessary for said configuration loader operation; and
operative to said configuration loader successfully verifying said communications necessary for said configuration loader operation:
said configuration loader module executing said list of tasks beginning with said failed task.

25. The article of manufacture of claim 21, wherein said system further comprises a first network interface client computer capable of communicating with said at least one information storage and retrieval system configuration source and said configuration loader and where said program of machine-readable instructions further causes:
said configuration loader establishing communications with said at least one information storage and retrieval system source using said first network interface client computer to communicate configuration information with respect to said at least one information storage and retrieval system source;
operative to said configuration loader detecting an incomplete execution of a failed task caused by a communication problem with said at least one information storage and retrieval system source:
said configuration loader reestablishing communication with said at least one information storage and retrieval system source using said first network interface client computer;
said configuration loader performing a verification of said communications necessary for said configuration loader operation; and
operative to said configuration loader successfully verifying said communications necessary for said configuration loader operation using said first network interface client computer:
said configuration loader executing said list of tasks beginning with said failed task.

26. The article of manufacture of claim 25 wherein said system further comprises a second network interface client computer capable of communicating with said at least one information storage and retrieval system configuration source and said configuration loader and where said program of machine-readable instructions further causes:
operative to said configuration loader not successfully verifying said communications necessary for said configuration loader operation using said first network interface client computer:
said configuration loader establishing communication with said at least one information storage and retrieval system source using said second network interface client computer to communicate configuration information with respect to said at least one information storage and retrieval system source;
said configuration loader performing a verification of said communications necessary for said configuration loader operation using said second network interface client computer; and
operative to said configuration loader successfully verifying said communications necessary for said configuration loader operation using said second network interface client computer:
said configuration loader executing said list of tasks beginning with said failed task.

27. The article of manufacture of claim 21, wherein said system further comprises a first network interface client computer capable of communicating with said at least one target information storage and retrieval system and said configuration loader and where said program of machine-readable instructions further causes:
said configuration loader establishing communication with said at least one target information storage and retrieval system using said first network interface client computer to communicate configuration information with respect to said at least one target information storage and retrieval system;
operative to said configuration loader detecting an incomplete execution of a failed task caused by a communication problem with said at least one target information storage and retrieval system:
said configuration loader reestablishing communications with said at least one target information storage and retrieval system using said first network interface client computer;
said configuration loader performing a verification of communications necessary for said configuration loader operation; and
operative to said configuration loader successfully verifying said communications necessary for said configuration loader operation using said first network interface client computer:
said configuration loader executing said list of tasks beginning with said failed task

28. The article of manufacture of claim 27 wherein said system further comprises a second network interface client computer capable of communicating with said at least one target information storage and retrieval system and said configuration loader and where said program of machine-readable instructions further causes:
operative to said configuration loader not successfully verifying said communications necessary for said configuration loader operation using said first network interface client computer:
said configuration loader establishing communication with said at least one target information storage and retrieval system using said second network interface client computer to communicate configuration information with respect to said at least one target information storage and retrieval system;
said configuration loader performing a verification of said communications necessary for said configuration loader operation using said second network interface client computer; and
operative to said configuration loader successfully verifying communications necessary for said configuration loader operation using said second network interface client computer:
said configuration loader executing said list of tasks beginning with said failed task.

29. A method for deploying computing infrastructure, comprising integrating computer readable code into a system to configure information storage and retrieval systems, wherein the code in combination with said system is capable of performing the following:
generating a list of tasks necessary to configure at least one target information storage and retrieval system to be equivalent to at least one information storage and retrieval system configuration source;
storing said list of tasks in at least one database; and
configuring said at least one target information storage and retrieval system by executing said list of tasks.

30. The method of claim 29, wherein the code in combination with said system is further capable of storing said list of tasks in a persistent database.

31. The method of claim 29, wherein the code in combination with said system is further capable of:
retrieving each task of said list of tasks from said at least one database; and
removing said each task from said list of tasks stored in said at least one database upon completion of execution of said each task.

32. The method of claim 29, wherein the code in combination with said system is further capable of:
operative to detecting an incomplete execution of a failed task:
performing a verification of communications necessary for a configuration loader operation; and
operative to said configuration loader successfully verifying said communications necessary for said configuration loader operation:
executing said list of tasks beginning with said failed task.
